(19) United States
(12) Patent Application Publication
(10) Pub. No.: US 2013/0308063 A1
(43) Pub. Date: Nov. 21, 2013

(54) METHOD, SYSTEM, AND DEVICE FOR RELAYING INFORMATION THROUGH A MOBILE PHONE OR PERSONAL DISPLAY DEVICE

(71) Applicant: SYNCHEAR, LLC, Carrboro, NC (US)

(72) Inventors: Kevin A. Szogas, Chapel Hill, NC (US); Stephen C. Friedman, Chapel Hill, NC (US)

(73) Assignee: SYNCHEAR, LLC, Carrboro, NC (US)

(21) Appl. No.: 13/796,778

(22) Filed: Mar. 12, 2013

Related U.S. Application Data
(60) Provisional application No. 61/648,340, filed on May 17, 2012.

(51) Int. Cl. H04N 5/60

(52) U.S. Cl. CPC H04N 5/60
USPC 348/738

(57) ABSTRACT

A system and related method are disclosed herein. The system includes an entertainment device having an audio signal and a video signal, a signal broadcasting device that broadcasts the audio signal of the entertainment device, and a mobile computing device. The mobile computing device may contain computer programmable code that is configured to receive, from the signal broadcasting device, the audio signal corresponding to the entertainment device and further output the audio signal. A server may be provided in communication with the signal broadcasting device and the mobile computing device and may be configured for sending advertising media to the mobile computing device.

### CROSS-REFERENCE TO RELATED APPLICATIONS

This application claims priority to U.S. Provisional Patent Application No. 61/648,340, filed on May 17, 2012, the entire contents of which are hereby incorporated by reference.

### TECHNICAL FIELD

This disclosure is related to a method and device for transmitting the audio from a television or other display to a mobile phone or personal display device configured for relaying information sent from a television or other display.

### BACKGROUND

In many commercial and other venues, a plurality of display screens may be provided for viewing by patrons. For example, in a bar or similar establishment, there may be multiple televisions for viewing by patrons, with each television being tuned to a desired television station or television program. However, in this scenario in which multiple televisions are provided and more than one television station is selected, the commercial establishment will turn the audio off or tune the audio for the entire establishment to only one station or program. In this scenario, the patrons must listen to the selected audio, which may not match the video for the station that they are viewing.

One solution to this problem has been to provide a speaker assembly at each table or booth in the commercial establishment. The patron directs the speaker assembly to transmit the audio corresponding to the television station or program that they are viewing. This solution is not acceptable at a bar or in an airport or on a street. It is also problematic because of the cost associated with such a system. The commercial establishment must provide speaker assemblies at each table and an infrastructure system for communicating with each of those speaker assemblies. For example, the speaker assemblies require a power source for operating. The commercial establishment must either hard wire the speaker assemblies into a permanent power source or provide batteries that require frequent replacement.

A need therefore exists for a method or solution that addresses these disadvantages.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein is a system. The system includes an entertainment device having an audio signal and a video signal, a signal broadcasting device that broadcasts the audio signal of the entertainment device, and a mobile computing device containing computer programmable code. The programmable code is configured to control the computing device to receive, from the signal broadcasting device, the audio signal corresponding to the entertainment device, and output the audio signal.

According to one or more embodiments disclosed herein, the system includes a server having a series of first identifiers and a series of second identifiers. Each of the first identifier is associated with a respective second identifier. The signal broadcasting device broadcasts one of the first identifiers. The computer programmable code is configured to direct the computing device to receive, from the signal broadcasting device, the first identifier. The code is configured to send, to the server, the first identifier. The code is configured to receive, from the server, the second identifier associated with the first identifier. The code is configured to transmit, to the signal broadcasting device, the second identifier. The code is configured to receive, from the signal broadcasting device, the audio signal associated with the second identifier.

According to one or more embodiments disclosed herein, the second identifier is a MAC address of the signal broadcasting device.

According to one or more embodiments disclosed herein, the mobile computing device is configured to display, on a display screen, an icon of the second identifier.

According to one or more embodiments disclosed herein, multiple mobile computing devices receive, from the signal broadcasting device, the audio signal associated with the second identifier.

According to one or more embodiments disclosed herein, the system includes a server having an advertising bank and being in communication with the mobile computing device. The mobile computing device includes computer programmable code configured to receiving an advertisement from the advertising bank of the server.

According to one or more embodiments disclosed herein, the signal broadcasting device is a Bluetooth® enabled device.

According to one or more embodiments disclosed herein, the mobile computing device is a Smartphone, tablet, laptop computer or audio device.

According to one or more embodiments disclosed herein, multiple mobile computing devices each receive, from the signal broadcasting device, the audio signal.

According to one or more embodiments disclosed herein, the mobile computing device includes computer programmable code configured to determine, from a plurality of audio signals from a respective plurality of signal broadcasting devices, a desired audio signal corresponding to a desired entertainment device for being output at the mobile computing device.

According to one or more embodiments disclosed herein, the signal broadcasting device broadcasts more than one audio signal.

According to one or more embodiments disclosed herein, the audio signal is processed using one of Advanced Audio Distribution Profile (A2DP), Hand Free Profile digital data stream, and SPP profile.

According to one or more embodiments disclosed herein, the mobile computing device is configured to receive, from the signal broadcasting device, one of audio and video advertisements.

According to one or more embodiments disclosed herein, each entertainment device has a corresponding signal broadcasting device.

According to one or more embodiments disclosed herein, the entertainment device is a television.

According to one or more embodiments disclosed herein, a method is provided. The method includes, at a signal broadcasting device, communicating with an entertainment device having an audio signal and a video signal, receiving the audio signal, and sending the audio signal to a mobile computing device.

According to one or more embodiments disclosed herein, communicating with an entertainment device comprises communicating with a television.

According to one or more embodiments disclosed herein, sending the audio signal to a mobile computing device comprises sending the audio signal over a Bluetooth enabled device.

According to one or more embodiments disclosed herein, the method includes sending advertising media to the mobile computing device.

According to one or more embodiments disclosed herein, a method is provided. The method includes, at a mobile computing device, receiving an audio signal that corresponds to the audio signal of a entertainment device from a signal broadcasting device, and outputting the audio signal.

According to one or more embodiments disclosed herein, the method includes receiving advertising media from a server having an advertising bank when the audio signal is received by the mobile computing device.

According to one or more embodiments disclosed herein, the method includes receiving, from the signal broadcasting device, a first identifier, sending, to a server, the first identifier, receiving, from the server, the second identifier associated with the first identifier, transmitting, to the signal broadcasting device, the second identifier, and receiving, from the signal broadcasting device, the audio signal associated with the second identifier.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 illustrates a schematic of a system according to one or more embodiments disclosed herein;

FIG. 2 illustrates a mobile computing device for use with one of the systems disclosed herein according to one or more embodiments disclosed herein;

FIG. 3 illustrates a mobile computing device for use with one of the systems disclosed herein according to one or more embodiments disclosed herein;

FIG. 4 illustrates a flow chart depicting one or more methods according to one or more embodiments disclosed herein; and

FIG. 5 illustrates a flow chart depicting one or more methods according to one or more embodiments disclosed herein.

### DETAILED DESCRIPTION

The presently disclosed invention is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies. Systems and methods for outputting an audio signal of an entertainment device on a mobile computing device are described herein.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, a server or other computer located within a retail environment and communicatively connected to other computing devices (e.g., point-of-sale (POS) equipment or computers) for managing accounting, purchase transactions, and other processes within the retail environment. In another example, a computing device may be a mobile computing device such as, for example, but not limited to, a Smartphone, a cell phone, a pager, a personal digital assistant (PDA), a mobile computer with a Smartphone client, or the like. A computing device can also include any type of conventional computer, for example, a laptop computer or a tablet computer. A typical mobile computing device is a wireless data access-enabled device (e.g., an iPHONE® Smartphone, a BLACKBERRY® Smartphone, a NEXUS ONE™ Smartphone, an iPAD® device, or the like) that is capable of sending and receiving data in a wireless manner using protocols like the Internet Protocol, or IP, and the wireless application protocol, or WAP. This allows users to access information via wireless devices, such as Smartphones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or Smartphone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a Smartphone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

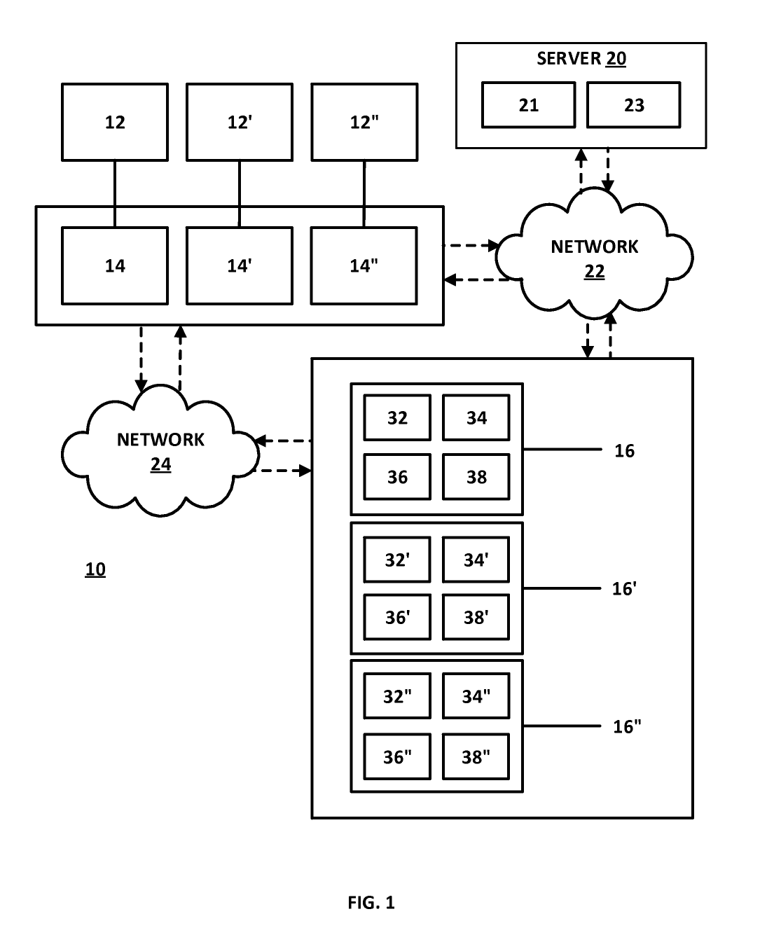

The presently disclosed subject matter is now described in more detail. For example, FIG. 1 illustrates a block diagram of a system 10 according to embodiments disclosed herein. The system 10 may be implemented in whole or in part in any suitable environment where persons gather to view one or more entertainment devices. As used herein, entertainment devices may be a television, movie theater screen, projector, and the like. These devices may be used in, for the example of a television, in a bar or other establishment. In such establishments, many people gather and focus their attention on a desired one of many televisions. In many instances, the audio of the television that a person desires to watch is either mute or otherwise inaudible to the person. This may be due to background noise or other interfering noise from other televisions and/or other patrons. System 10 provides a manner for the person to receive the audio of the television or other entertainment device.

FIG. 1 illustrates a system according to one or more embodiments disclosed herein and generally designated as 10. The system 10 may include an entertainment device 12. Additional entertainment devices 12′ and 12″ may also be provided. Each entertainment device 12 may have an audio and video signal associated therewith. For example, if entertainment device 12 is a television, the television may receive an audio and video signal. This signal may come from a cable service provider that communicates via a coaxial cable, high definition cable, and the like, or may be from a satellite signal. Alternatively, signal may be from a pre-recorded medium such as, for example, a tape or compact diskette or use of a Digital Video Recording (DVR) service or the like.

In one or more embodiments, the entertainment device 12 is configured for a display or pre-recorded program. Entertainment device 12 may be selected by a user or patron in the establishment. The user or patron of the establishment will have a choice selecting from amongst a number of entertainment devices. One of the choices is entertainment device 12.

System 10 may further include a signal broadcasting device 14. Additional signal broadcasting devices 14′ and 14″ may also be provided. Each entertainment device 12 may be operably coupled to a respective signal broadcasting device 14, a plurality of entertainment devices 12 may be operably coupled to a single signal broadcasting device 14, or a single entertainment device 12 may be operably coupled with a plurality of signal broadcasting devices 14. Each signal broadcasting device 14 is configured to communicate with a server 20 via network 22. Network 22 may also be a wireless local area network (WLAN) managed by the establishment. Network 22 may be the Internet, a mobile and/or cellular network, and/or the like.

Server 20 may be provided with various programs and computing capabilities that will be further described herein. Server 20 may include an advertising bank 21 that includes one or more advertising media for display such as, for example, audio, video, and/or imaging media to be displayed on any device communicating with server 20. Additionally, server 23 may include an identifier bank 23 that is configured for identifying signal broadcasting device 14 and any requests from a mobile computing device 16 that is attempting to communicate through one of the signal broadcasting device 14.

Each signal broadcasting device 14 is configured to communicate at least the audio signal of the entertainment device 12. The server 20 may be configured to communicate additional signals, such as video corresponding to a program on the entertainment device 12 or advertising media via network 22. For example, server 20 may be configured to communicate one or more advertisements from advertisement bank 21 via network 22 to each of mobile computing devices 16, 16′, and 16″. In this particular embodiment, network 22 may be a cellular network or the like.

In one or more embodiments, the signal broadcasting device 14 may be configured for broadcasting only the audio signal corresponding to the one entertainment device 12 to which the signal broadcasting device 14 is associated therewith. Alternatively, the signal broadcasting device 14 may be configured to broadcast multiple audio signals associated with multiple entertainment devices 12 and the mobile computing device 16 may be provided with an appropriate application for allowing the user to select a desired programming of the multiple entertainment devices 12. The signal broadcasting device 14 is configured to broadcast the audio signal via network 24. Network 24 may be a wireless local area network (WLAN) managed by the establishment. Network 24 may also be a Bluetooth® enabled network. Signal broadcasting device 14 is configured to broadcast the audio signal through network 24 to a mobile computing device 16. The signal may be processed using one of Advanced Audio Distribution Profile (A2DP), Hand Free Profile digital data stream, and SPP profile. One or more mobile computing devices 16′ and 16″ may also be provided.

Mobile computing device 16 may be a Smartphone or similar device such as, for example, a personal display device. Mobile computing device 16 may include a processor 32 and a memory 34. Memory 34 may include computer control code configured for controlling one or more features to be displayed and/or broadcast on the mobile computing device 16. The mobile computing device 16 may further include a user interface 36, such as, for example, a display screen for displaying video output and a touch responsive screen for allowing the user to input various commands to the mobile computing device 16. The mobile computing device may further include a communications module 38, which may be, for example, an antenna or a wireless transmitter. The communications module 38 may be provided for communicating with either of network 22 or network 24.

The identifier bank 23 of server 20 may have a series of first identifiers and a series of second identifiers. Each of the first identifier is associated with a respective second identifier. In one or more embodiments, the signal broadcasting device 14 broadcasts one of the first identifiers. The computer programmable code on mobile device 16 is then configured to receive, from the signal broadcasting device 14, the first identifier. The computer programmable code is then configured to send, to the server 20, the first identifier. The computer programmable code is then configured to receive, from the server 20, the second identifier associated with the first identifier. The computer programmable code is then configured to transmit, to the signal broadcasting device 14, the second identifier. The computer programmable code is then configured to receive, from the signal broadcasting device 14, the audio signal associated with the second identifier. In this manner, once server 20 and signal broadcasting device 12 have passed identifiers, the server 20 is able to determine that a request for audio signal from a respective mobile computing device 16 is authenticated and can also determine which audio signal of a selected entertainment device 12 is to be sent to the mobile computing device 16. The sending and receiving accomplished by the computer programmable code may be accomplished through communications module 38.

In one or more embodiments, the second identifier may be a MAC address of the signal broadcasting device 14. In one or more embodiments, the mobile computing device 12 may have computer control code configured to display, on the user interface 36, an icon of the second identifier.

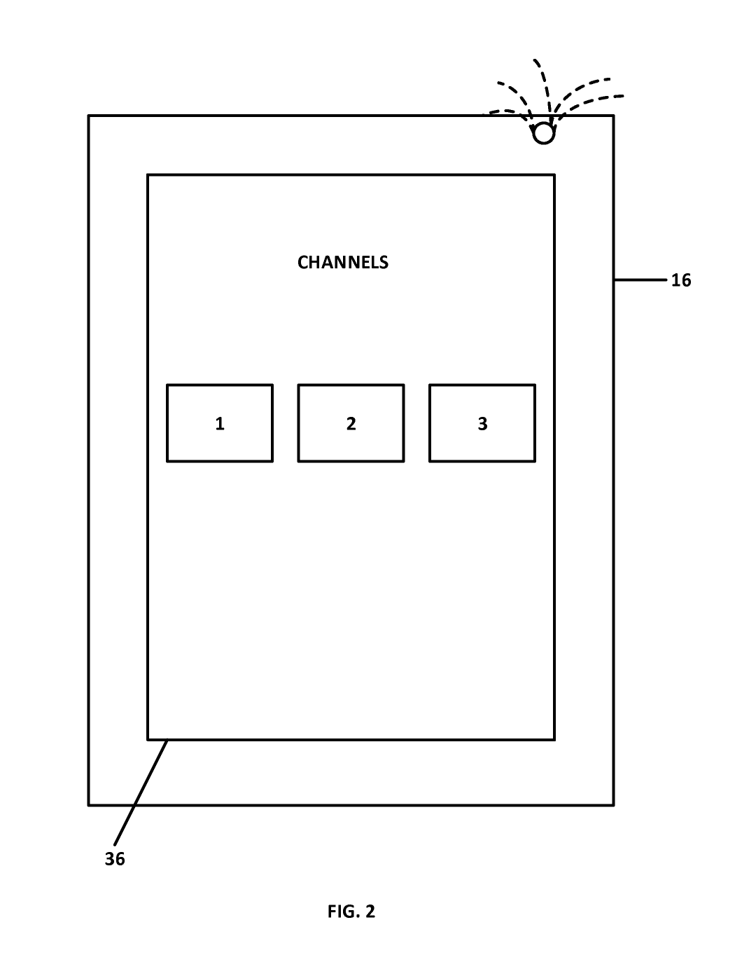

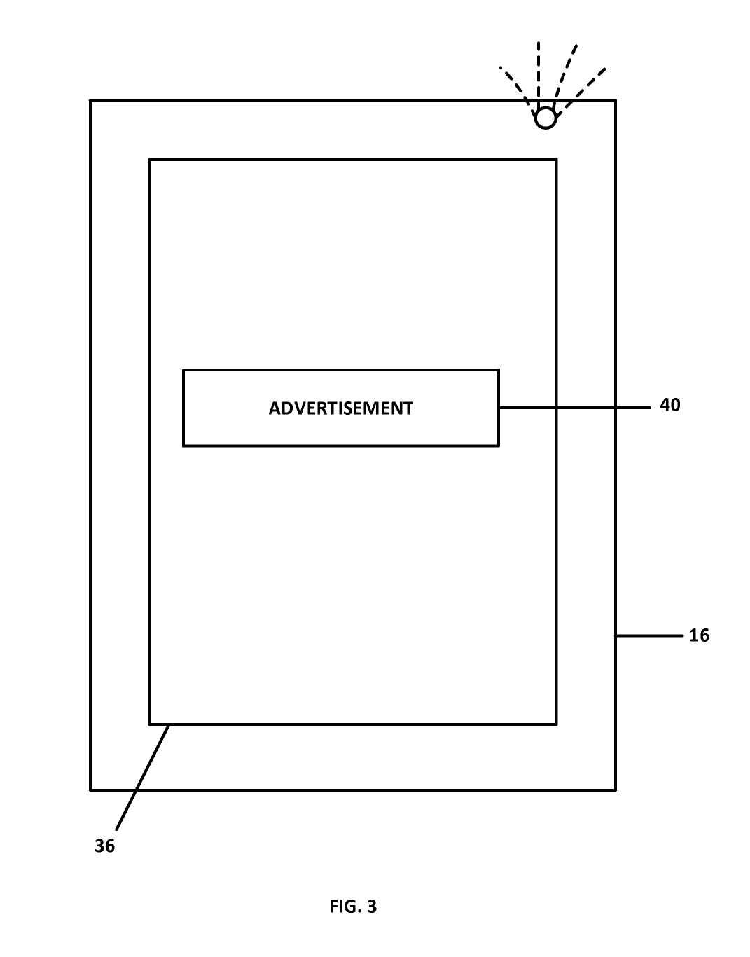

Mobile computing device 16 is illustrated in FIG. 2 and FIG. 3. The mobile computing device 16 may have computer control code embodied in an application installed on the memory 34. Applications may be provided for download from network 22 or network 24. As illustrated in FIG. 2, the mobile computing device may display touch-responsive buttons 1, 2, and 3 on the user interface 36. Touch-responsive buttons 1, 2, and 3 may correspond directly with entertainment devices 12, 12′, and 12″. An illustrative example showing three touch-responsive buttons in FIG. 2 is just one such example. In one or more embodiments, 64 or more numbered buttons may be provided. In this manner, the user can select the touch-responsive button on user interface 36 that corresponds to a desired entertainment device 12. For example, if the user wants to select entertainment device 12, they can select touch-responsive button 1. The mobile computing device 16 may then utilize the one or more authentication methods disclosed herein in order to be granted access to the audio output from signal broadcasting device 14.

As illustrated in FIG. 3, server 20, or in alternate embodiments, signal broadcasting device 14, may communicate via either network 22 or network 24, advertising media 40 for display on user interface 36. In this manner, during the period of time that mobile computing device 16 is outputting audio signals from the signal broadcasting device 14, advertising media 40 may be displayed on the user interface 36. This may represent a source of revenue for the provider of the broadcasting device 14 and associated paraphernalia, the establishment or other service providers. Additionally, special announcements such as may be required in an airport setting may also provide a revenue generating opportunity. The advertising media 40 may be video, audio, image, and the like. The one or more advertising media 40 are stored within advertising bank 21 of server 20.

Additionally, signal broadcasting device 14 may be configured to transmit the audio, video, or both the audio and video corresponding to each of the television programs or other programs from entertainment device 12 being displayed at any given moment by the one or more entertainment devices 12 in the commercial establishment

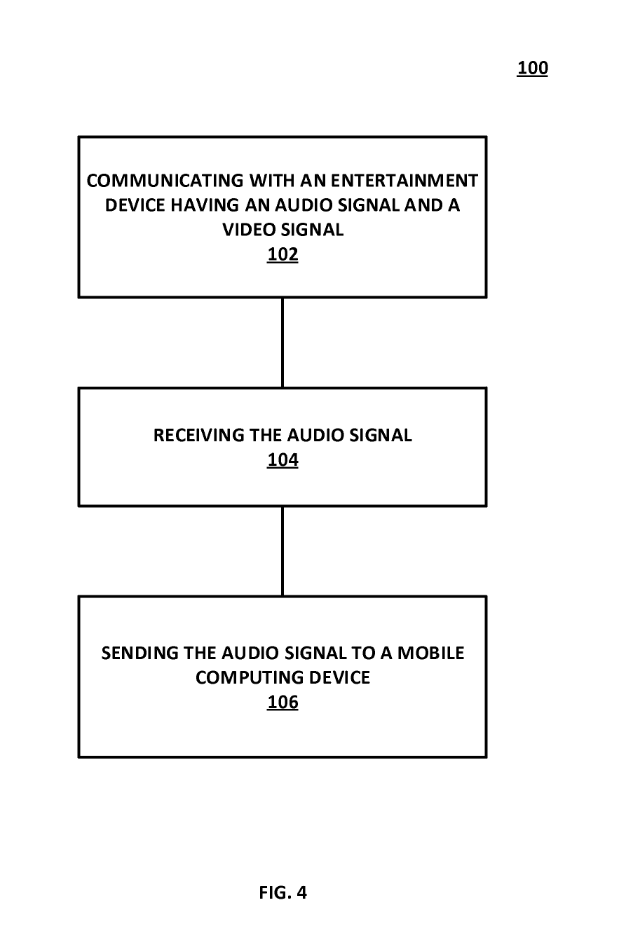

One or more methods are illustrated in FIG. 4 and generally designated 100. The one or more methods 100 may include communicating 102 with an entertainment device having an audio signal and a video signal. Communicating with an entertainment device may include communicating with a television, movie screen, projected audio and video or other digitally transmitted medium. Entertainment device may be device 12 and the communication may be through signal broadcasting device 14. The one or more methods 100 may include receiving 104 the audio signal. This audio signal may be received at the mobile computing device 16 and may be received from either of the server 20 via network 22 or signal broadcasting device 14 via network 24. The one or more methods 100 may include sending 106 the audio signal to a mobile computing device. Sending the audio signal may include sending the audio signal over a Bluetooth® enabled device such as signal broadcasting device 14. The one or more methods 100 may include sending advertising media to the mobile computing device. The advertising media may be sent from server 20 through network 22.

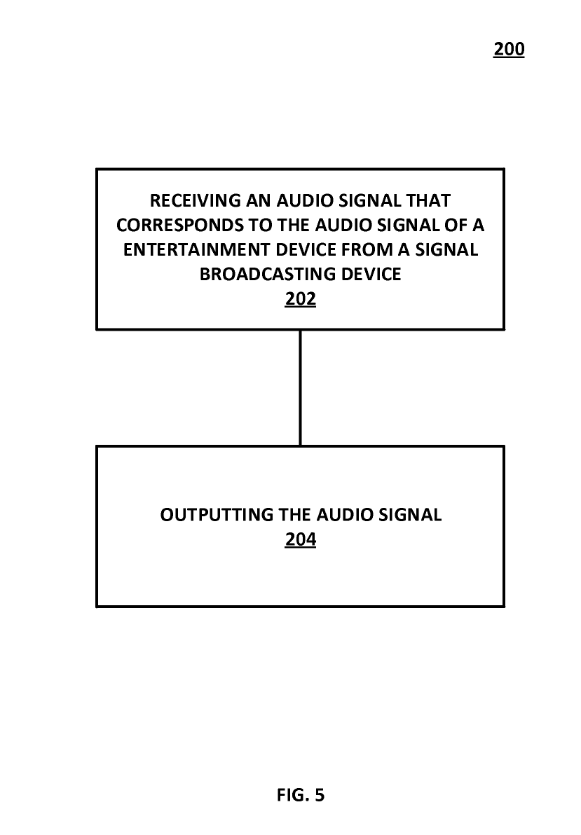

One or more methods are illustrated in FIG. 5 and generally designated 200. The one or more methods 200 may include receiving 202 an audio signal that corresponds to the audio signal of an entertainment device from a signal broadcasting device. The audio signal may be received from signal broadcasting device 14 that communicates through network 24. The one or more methods 200 may further include outputting 204 the audio signal.

The one or more methods 200 may also include receiving, from the signal broadcasting device, a first identifier. The one or more methods 200 may also include sending, to a server, the first identifier. The one or more methods 200 may also include receiving, from the server, the second identifier associated with the first identifier. The one or more methods may also include transmitting, to the signal broadcasting device, the second identifier. The one or more methods may also include receiving, from the signal broadcasting device, the audio signal associated with the second identifier. The second identifier may be a MAC address.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A system comprising:
an entertainment device having an audio signal and a video signal;
a signal broadcasting device that broadcasts the audio signal of the entertainment device; and
a mobile computing device containing computer programmable code configured to:
receive, from the signal broadcasting device, the audio signal corresponding to the entertainment device; and
output the audio signal.

2. The system of claim 1, further including a server having a series of first identifiers and a series of second identifiers, each of the first identifier being associated with a respective second identifier,
wherein the signal broadcasting device broadcasts one of the first identifiers, and further wherein, the computer programmable code is configured to:
receive, from the signal broadcasting device, the first identifier;
send, to the server, the first identifier;
receive, from the server, the second identifier associated with the first identifier;
transmit, to the signal broadcasting device, the second identifier; and
receive, from the signal broadcasting device, the audio signal associated with the second identifier.

3. The system of claim 2, wherein the second identifier is a MAC address of the signal broadcasting device.

4. The system of claim 2, wherein the mobile computing device is configured to display, on a display screen, an icon of the second identifier.

5. The system of claim 4, wherein multiple mobile computing devices receive, from the signal broadcasting device, the audio signal associated with the second identifier.

6. The system of claim 1, further including:
a server having an advertising bank and being in communication with the mobile computing device,
wherein the mobile computing device comprises computer programmable code configured to receiving an advertisement from the advertising bank of the server.

7. The system of claim 1, wherein the signal broadcasting device is a Bluetooth® enabled device.

8. The system of claim 1, wherein the mobile computing device is a Smartphone, tablet, laptop computer or audio device.

9. The system of claim 1, wherein multiple mobile computing devices each receive, from the signal broadcasting device, the audio signal.

10. The system of claim 1, wherein the mobile computing device comprises computer programmable code configured to:
determine, from a plurality of audio signals from a respective plurality of signal broadcasting devices, a desired audio signal corresponding to a desired entertainment device for being output at the mobile computing device.

11. The system of claim 1, wherein the signal broadcasting device broadcasts more than one audio signal.

12. The system of claim 1, wherein the audio signal is processed using one of Advanced Audio Distribution Profile (A2DP), Hand Free Profile digital data stream, and SPP profile.

13. The system of claim 1, wherein the mobile computing device is configured to receive, from the signal broadcasting device, one of audio and video advertisements.

14. The system of claim 1, wherein each entertainment device has a corresponding signal broadcasting device.

15. The system of claim 1, wherein the entertainment device is a television.

16. A method comprising:
at a signal broadcasting device:
communicating with an entertainment device having an audio signal and a video signal;
receiving the audio signal; and
sending the audio signal to a mobile computing device.

17. The method of claim 16, wherein communicating with an entertainment device comprises communicating with a television.

18. The method of claim 16, wherein sending the audio signal to a mobile computing device comprises sending the audio signal over a Bluetooth enabled device.

19. The method of claim 16, further comprising sending advertising media to the mobile computing device.

20. A method comprising:
at a mobile computing device:
receiving an audio signal that corresponds to the audio signal of a entertainment device from a signal broadcasting device; and
outputting the audio signal.

21. The method of claim 20, further comprising receiving advertising media from a server having an advertising bank when the audio signal is received by the mobile computing device.

22. The method of claim 18, further comprising:
receiving, from the signal broadcasting device, a first identifier;
sending, to a server, the first identifier;
receiving, from the server, the second identifier associated with the first identifier;
transmitting, to the signal broadcasting device, the second identifier; and
receiving, from the signal broadcasting device, the audio signal associated with the second identifier.
